(19) United States
(12) Patent Application Publication
(10) Pub. No.: US 2023/0229479 A1
(43) Pub. Date: Jul. 20, 2023

(54) APPLICATION TOPOLOGY DERIVATION IN A VIRTUALIZED COMPUTING SYSTEM

(71) Applicant: VMWARE, INC., Palo Alto, CA (US)

(72) Inventors: ANKITA SHARMA, Bangalore (IN); AHIL KANNA, Bangalore (IN); SRI NARAYANAN THANGA NADAR, Bangalore (IN); AMAN SINGH, Bangalore (IN); SHIVAKUMAR SOMAPUR, Bangalore (IN); ASHOK ALETTY, San Ramon, CA (US)

(21) Appl. No.: 17/695,883

(22) Filed: Mar. 16, 2022

(30) Foreign Application Priority Data
Jan. 15, 2022 (IN) 202241002420

(51) Int. Cl. G06F 9/455

(52) U.S. Cl. CPC G06F 9/45558; G06F 9/45545; G06F 2009/4557; G06F 2009/45579; G06F 2009/45595

(57) ABSTRACT

An example method of determining application topology in a virtualized computing system having a cluster of hosts with hypervisors supporting virtual machines (VMs), the method including: executing agents on the VMs to obtain process metadata describing processes executing in the VMs; receiving, at an application analysis system, the process metadata; receiving network flow metadata from the agents on the VMs and/or from a network analyzer in the virtualized computing system; parsing the network flow metadata to identify a source VM and a destination VM of the VMs; relating the network flow metadata to portions of the process metadata associated with the source and the destination VMs to identify a source process and a destination process; and generating a topology of a source component connected to a destination component, the source component identifying the source VM and the source process, the destination component identifying the destination VM and the destination process.

### RELATED APPLICATION

Benefit is claimed under 35 U.S.C. 119(a)-(d) to Foreign Application Serial No. 202241002420 filed in India entitled “APPLICATION TOPOLOGY DERIVATION IN A VIRTUALIZED COMPUTING SYSTEM”, on Jan. 15, 2022, by VMware, Inc., which is herein incorporated in its entirety by reference for all purposes.

Applications today are deployed onto a combination of virtual machines (VMs), containers, application services, physical servers without virtualization, and more within a software-defined datacenter (SDDC). The SDDC includes a server virtualization layer having clusters of physical servers that are virtualized and managed by virtualization management servers. Each host includes a virtualization layer (e.g., a hypervisor) that provides a software abstraction of a physical server (e.g., central processing unit (CPU), random access memory (RAM), storage, network interface card (NIC), etc.) to the VMs. A user, or automated software on behalf of an Infrastructure as a Service (IaaS), interacts with a virtualization management server to create server clusters (“host clusters”), add/remove servers (“hosts”) from host clusters, deploy/move/remove VMs on the hosts, deploy/configure networking and storage virtualized infrastructure, and the like. The virtualization management server sits on top of the server virtualization layer of the SDDC and treats host clusters as pools of compute capacity for use by applications.

Applications executing in a virtualized computing system can include many software components. A user’s view of the applications via virtualization management tools can drift from the actual state of the applications as the virtualized computing system and applications evolve over time. A user may be unaware of the application software executing in the VMs. It is desirable to provide an application discovery process that is automated and provides a more accurate view of applications, their components, relationships, dependencies, and interdependencies.

### SUMMARY

Embodiments include a method of determining application topology in a virtualized computing system having a cluster of hosts, the hosts including hypervisors supporting virtual machines (VMs). The method includes: executing agents on the VMs to obtain process metadata describing processes executing in the VMs; receiving, at an application analysis system, the process metadata; receiving, at the application analysis system, network flow metadata from the agents on the VMs, from a network analyzer in the virtualized computing system, or from both the agents and the network analyzer; parsing, by the application analysis system, the network flow metadata to identify a source VM and a destination VM of the VMs; relating, by the application analysis system, the network flow metadata to portions of the process metadata associated with the source and the destination VMs to identify a source process and a destination process; and generating, by the application analysis software, a topology of a source component connected to a destination component, the source component identifying the source VM and the source process, the destination component identifying the destination VM and the destination process.

Further embodiments include a non-transitory computer-readable storage medium comprising instructions that cause a computer system to carry out the above methods, as well as a computer system configured to carry out the above methods.

### BRIEF DESCRIPTION OF THE DRAWINGS

FIG. 1 is a block diagram of a virtualized computing system in which embodiments described herein may be implemented.

FIG. 2 is a block diagram depicting the logical structure of software executing in a virtualized computing system according to embodiments.

FIG. 3 is a block diagram depicting a host according to embodiments.

FIG. 4 is a block diagram depicting logic and data of an application analysis system according to embodiments.

FIG. 5 is a flow diagram depicting a method of determining application component topologies according to embodiments.

FIG. 6 is a flow diagram depicting a method of identifying source and destination components in a metadata matching process performed by an application analysis system according to embodiments.

FIG. 7 is a block diagram depicting an example connection between processes according to embodiments.

FIG. 8 is a block diagram depicting another example connection between processes according to embodiments.

### DETAILED DESCRIPTION

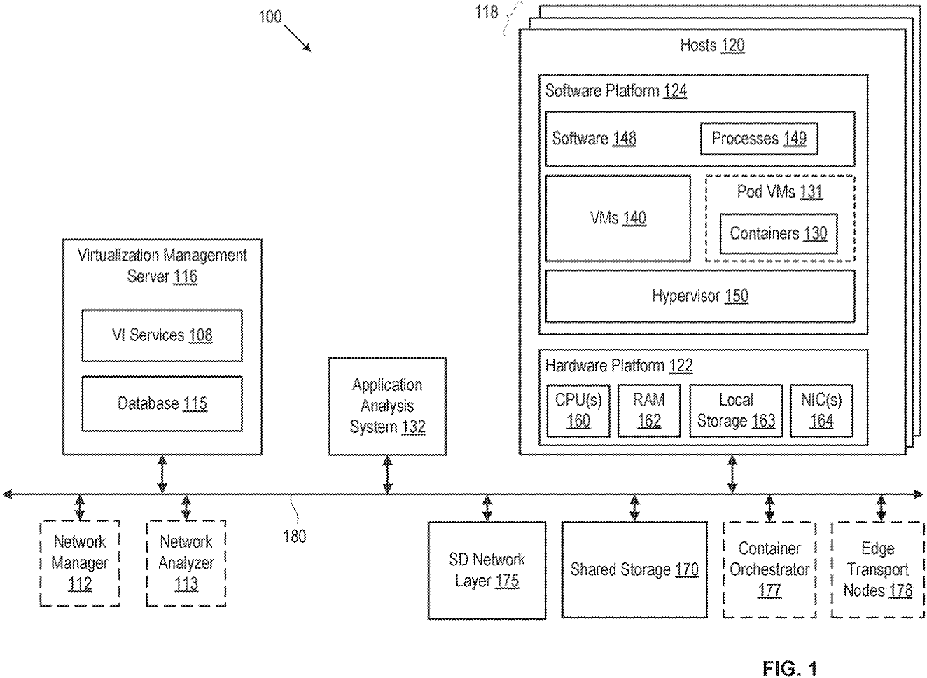

FIG. 1 is a block diagram of a virtualized computing system 100 in which embodiments described herein may be implemented. Virtualized computing system 100 comprises a software-defined data center (SDDC) that includes hosts 120. Hosts 120 may be constructed on server-grade hardware platforms such as an x86 architecture platforms. One or more groups of hosts 120 can be managed as clusters 118. As shown, a hardware platform 122 of each host 120 includes conventional components of a computing device, such as one or more central processing units (CPUs) 160, system memory (e.g., random access memory (RAM) 162), one or more network interface controllers (NICs) 164, and optionally local storage 163. CPUs 160 are configured to execute instructions, for example, executable instructions that perform one or more operations described herein, which may be stored in RAM 162. NICs 164 enable host 120 to communicate with other devices through a physical network 180. Physical network 180 enables communication between hosts 120 and between other components and hosts 120 (other components discussed further herein).

In the embodiment illustrated in FIG. 1, hosts 120 access shared storage 170 by using NICs 164 to connect to network 180. In another embodiment, each host 120 contains a host bus adapter (HBA) through which input/output operations (IOs) are sent to shared storage 170 over a separate network (e.g., a fibre channel (FC) network). Shared storage 170 include one or more storage arrays, such as a storage area network (SAN), network attached storage (NAS), or the like. Shared storage 170 may comprise magnetic disks, solid-state disks, flash memory, and the like as well as combinations thereof. In some embodiments, hosts 120 include local storage 163 (e.g., hard disk drives, solid-state drives, etc.). Local storage 163 in each host 120 can be aggregated and provisioned as part of a virtual SAN (vSAN), which is another form of shared storage 170.

A software platform 124 of each host 120 provides a virtualization layer, referred to herein as a hypervisor 150, which directly executes on hardware platform 122. In an embodiment, there is no intervening software, such as a host operating system (OS), between hypervisor 150 and hardware platform 122. Thus, hypervisor 150 is a Type-1 hypervisor (also known as a “bare-metal” hypervisor). As a result, the virtualization layer in host cluster 118 (collectively hypervisors 150) is a bare-metal virtualization layer executing directly on host hardware platforms. Hypervisor 150 abstracts processor, memory, storage, and network resources of hardware platform 122 to provide a virtual machine execution space within which multiple virtual machines (VM) 140 may be concurrently instantiated and executed. One example of hypervisor 150 that may be configured and used in embodiments described herein is a VMware ESXi™ hypervisor provided as part of the VMware vSphere® solution made commercially available by VMware, Inc. of Palo Alto, CA.

Software 148 executes in VMs 140 (e.g.. guest operating systems, applications, etc.) and includes processes 149. A process 149 is an instance of a computer program. A process includes a portion of the computer’s (e.g., a VM 140) virtual memory, which is occupied by the computer program’s executable code and data, and a data structure maintained by the computer’s operating system. For example, the Linux® operating system maintains a data structure for each process known as a Process Control Block (PCB). The data structure includes information such as the process running state, the process scheduling state, memory management information, interprocess communication (IPC) information, open file descriptors held by the process, and the like. Other commercial operating systems include similar data structures for each process.

Virtualized computing system 100 is configured with a software-defined (SD) network layer 175. SD network layer 175 includes logical network services executing on virtualized infrastructure of hosts 120. The virtualized infrastructure that supports the logical network services includes hypervisor-based components, such as resource pools, distributed switches, distributed switch port groups and uplinks, etc., as well as VM-based components, such as router control VMs, load balancer VMs, edge service VMs, etc. Logical network services include logical switches and logical routers, as well as logical firewalls, logical virtual private networks (VPNs), logical load balancers, and the like, implemented on top of the virtualized infrastructure. In embodiments, virtualized computing system 100 includes edge transport nodes 178 that provide an interface of host cluster 118 to wide area network (WAN) (e.g., a corporate network, the public Internet, etc.). Edge transport nodes 178 can include a gateway (e.g., implemented by a router) between the internal logical networking of host cluster 118 and the external network. Edge transport nodes 178 can be physical servers or VMs. Virtualized computing system 100 also includes physical network devices (e.g., physical routers/switches) as part of physical network 180. which are not explicitly shown.

Virtualization management server 116 is a physical or virtual server that manages hosts 120 and the hypervisors therein. Virtualization management server 116 installs agent(s) in hypervisor 150 to add a host 120 as a managed entity. Virtualization management server 116 can logically group hosts 120 into host cluster 118 to provide cluster-level functions to hosts 120, such as VM migration between hosts 120 (e.g.. for load balancing), distributed power management, dynamic VM placement according to affinity and anti-affinity rules, and high-availability. The number of hosts 120 in host cluster 118 may be one or many. Virtualization management server 116 can manage more than one host cluster 118. While only one virtualization management server 116 is shown, virtualized computing system 100 can include multiple virtualization management servers each managing one or more host clusters.

In an embodiment, virtualized computing system 100 further includes a network manager 112. Network manager 112 is a physical or virtual server that orchestrates SD network layer 175. In an embodiment, network manager 112 comprises one or more virtual servers deployed as VMs. Network manager 112 installs additional agents in hypervisor 150 to add a host 120 as a managed entity, referred to as a transport node. One example of an SD networking platform that can be configured and used in embodiments described herein as network manager 112 and SD network layer 175 is a VMware NSX® platform made commercially available by VMware, Inc. of Palo Alto, CA. In other embodiments. SD network layer 175 is orchestrated and managed by virtualization management server 116 without the presence of network manager 112.

Virtualization management server 116 can include various virtual infrastructure (VI) services 108. VI services 108 can include various services, such as a management daemon, distributed resource scheduler (DRS), high-availability (HA) service, single sign-on (SSO) service, and the like. VI services 108 persist data in a database 115, which stores an inventory of objects, such as clusters, hosts, VMs, resource pools, datastores, and the like. Users interact with VI services 108 through user interfaces, application programming interfaces (APIs), and the like to issue commands, such as forming a host cluster 118, configuring resource pools, define resource allocation policies, configure storage and networking, and the like.

In embodiments, software 148 can also execute in containers 130. In embodiments, hypervisor 150 can support containers 130 executing directly thereon. In other embodiments, containers 130 are deployed in VMs 140 or in specialized VMs referred to as “pod VMs 131.” A pod VM 131 is a VM that includes a kernel and container engine that supports execution of containers, as well as an agent (referred to as a pod VM agent) that cooperates with a controller executing in hypervisor 150. In embodiments, virtualized computing system 100 can include a container orchestrator 177. Container orchestrator 177 implements an orchestration control plane, such as Kubernetes®, to deploy and manage applications or services thereof in pods on hosts 120 using containers 130. Container orchestrator 177 can include one or more master servers configured to command and configure controllers in hypervisors 150. Master server(s) can be physical computers attached to network 180 or implemented by VMs 140/131 in a host cluster 118.

In embodiments, virtualized computing system includes application analysis system 132. Application analysis system 132 can execute on one or more servers, which can be physical servers, VMs, containers, or some combination thereof. Application analysis system can execute in host cluster 118, execute external to host cluster 118, execute external to the SDDC, or some combination thereof.

Application analysis system 132 is configured to discover, collect, and store metadata about applications executing on host cluster 118. The collected metadata is useful for discovering the nature of constituent components of target applications and their topologies. The collected metadata can be used for various purposes, such as re-platforming a traditional application executing on operating systems to a containerized application executing in a container-based environment (e.g., Kubernetes®). In embodiments, application analysis software 132 installs agents in VMs 131/140 to collect information about executing processes during metadata collection. The term installation, as used herein, encompasses various forms of having agents be executed in VMs 131/140, such as a conventional installation process, adding agents to a template from which VMs 131/140 are provisioned, attaching virtual disks to VMs 131/140 having executable code of agents, instructing an interpreter in VMs 131/140 to execute a sequence of commands as agents, and the like. In general, application analysis system 132 configures VMs 131/140 to execute agents using any or a combination of such techniques. A user can access application analysis system 132 through user interfaces and/or APIs.

In embodiments, virtualized computing system 100 can include network analyzer 113. Network analyzer 113 is configured to perform various network analyses on SD network layer 175 and VMs 131/140 connected thereto. For example, network analyzer 113 can collect network flow information from virtualization management server 116 and/or network manager 112. The network flow information describes the network traffic flows between VMs 131/140. Network analyzer 113 can also detect communications with external services, such as domain name service (DNS), network time protocol (NTP), and the like as part of the network flow information. In embodiments, network analyzer 113 can be implemented using VMware vRealize® Network Insight™ commercially available from VMware, Inc. of Palo Alto, CA. Application analysis system 132 can leverage network flow information collected by network analyzer 113 to detect traffic flows between VMs and map such traffic flows to the identified application components to determine the application topology, as described further herein.

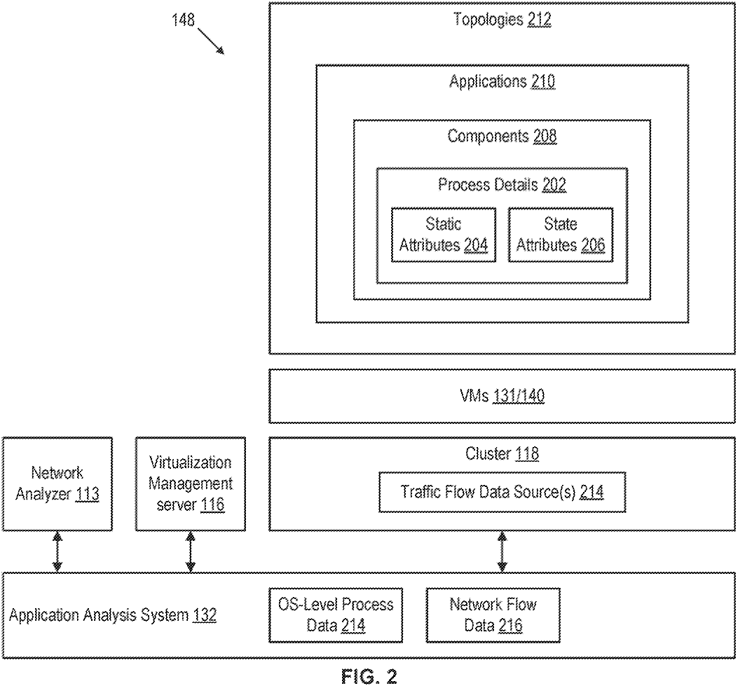

FIG. 2 is a block diagram depicting the logical structure of software executing in virtualized computing system 100 according to embodiments. Software 148 includes components 208 of applications 210 having topologies 212. Any running process or collection of processes that provides functionality for an application 210 is defined as a component 208. A component can include process details 202 that include a collection of attributes for the process(es) running on the computer. For example, process details 202 can include a set of static attributes 204 (e.g., unique identifier of a host on which the process executes, name of process, full path of the executable of the process, command line parameters used to invoke the process, working directory, environment variables, start time of the process, the process owner, and the like). The host identifier can be, for example, a virtual machine identifier (e.g., a VM universally unique identifier (UUID), a virtual machine managed object identifier, or a combination thereof). Process details 202 can further include state attributes 206, which describe the current state of process(es) (e.g., a list of open socket file descriptors, a list of open disk files, and the like). In general (but not always), a component has a one-to-one relationship with a running process on a computer. In some cases, a component can be associated with multiple processes. An application 210 is an implementation of functionality that includes one or more components 208, communication between components 208, and optionally services supporting the components 208 (e.g., network services). A topology is a physical or logical arrangement of multiple nodes communicating in a network. Each topology 212 represents a logical placement of components 208 of one or more applications 210 communicating with each other.

Software 148 executes in VMs 131/140 on hosts 120 in cluster 118 alongside virtualization management server 116 and network analyzer 113 (if present). Application analysis system 132 communicates with VMs 131/140 in cluster 118, virtualization management server 116, and network analyzer 113 (if present) to collect and store metadata for components 208. Application analysis system 132 can process the collected metadata to identify applications 210 and determine topologies 212. The metadata collected by application analysis system 132 includes OS-level process metadata 214 and network flow data 216. Application analysis system 132 obtains OS-level process metadata 214 from VMs 131/140. In embodiments, application analysis system 132 obtains some or all of network flow data 216 from VMs 131/140 (e.g., derived from OS-level process metadata 214 or collected independently). In embodiments, application analysis system 132 obtains some or all of network flow data 216 from network analyzer 113. Network analyzer 113 can collect network flow records from traffic flow data source(s) 214 in cluster 118. Example network flow records include NetFlow records and Internet Protocol Flow Information Export (IPFIX) records. NetFlow is a network protocol developed for collecting IP traffic information and monitoring network flow. IPFIX is a universal solution to collect and analyze useful network data.

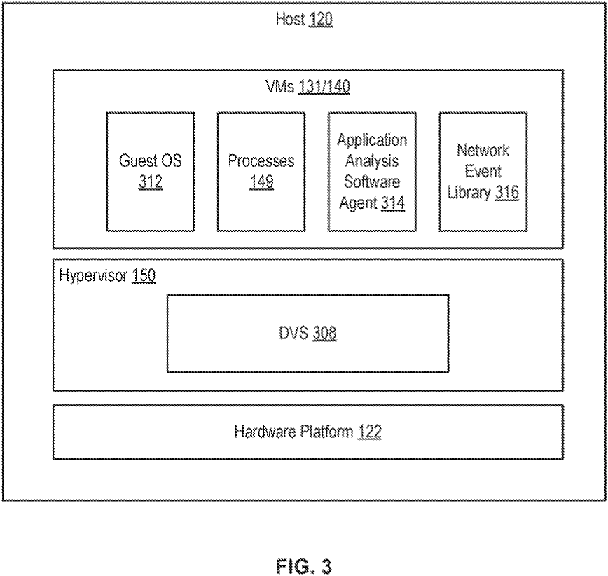

FIG. 3 is a block diagram depicting a host 120 according to embodiments. Host 120 includes VMs 131/140 managed by hypervisor 150 executing on hardware platform 122. Hypervisor 150 can include a distributed virtual switch (DVS) 308, which is a component of software distributed across hosts 120 in cluster 118 that functions as a network switch. DVS 308 can generate network flow records, which are collected by network analyzer 113. Each VM 131/140 includes a guest OS 312 (or kernel) that supports execution of processes 149. Application analysis system 132 installs or otherwise causes execution of application analysis software agent 314 in each VM 131/140 for collection of OS-level process metadata 214 from guest OS 312. In embodiments, a VM 131/140 can include a network event library 316 (e.g., libnetfilter), which is configured to collect network events processed by guest OS 312 over a period of time. Application analysis software agent 314 can obtain some network flow data 216 from network event library 316. Application analysis software agent 314 returns collected metadata to application analysis system 132 for processing. Application analysis software agent 314 can collect metadata periodically over time or upon command from application analysis system 132.

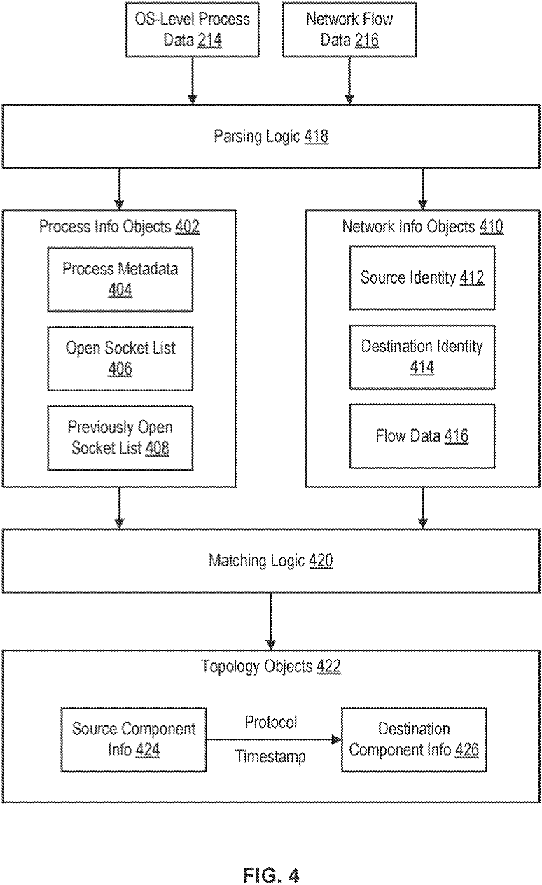

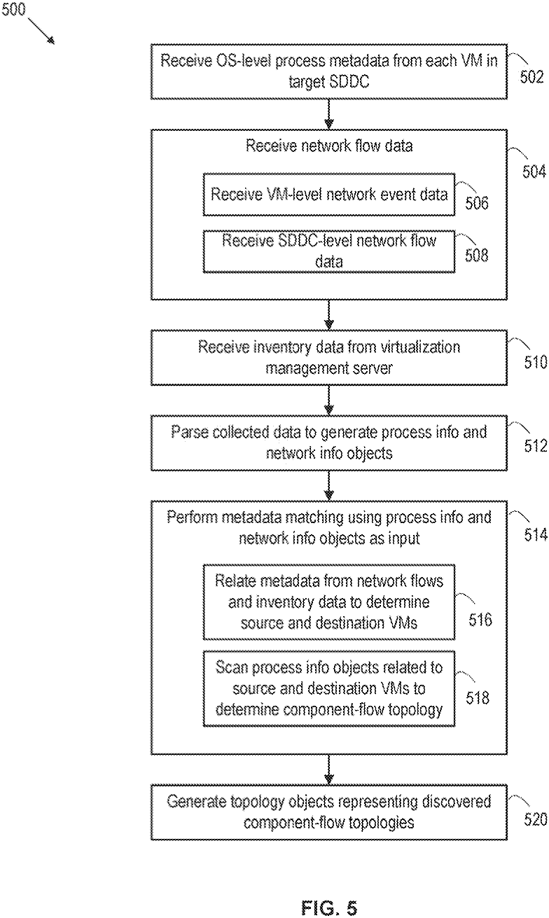

FIG. 4 is a block diagram depicting logic and data of application analysis system 132 according to embodiments. FIG. 5 is a flow diagram depicting a method 500 of determining application component topologies according to embodiments. Method 500 can be understood with respect to the logic depicted in FIG. 4. Method 500 begins at step 502, where application analysis system 132 receives OS-level process metadata 214 from each VM 131/140 in a target SDDC (virtualized computing system 100). A guest OS 312 includes process management commands that capture the running processes. For example, a Linux® OS includes a ‘ps’ command and a ‘/proc’ directory that will have a list of processes and their metadata. A Windows® OS includes a ‘GetProcess’ PowerShell command that gives process output and can be converted to JavaScript Object Notation (JSON) to give a list of all processes and their metadata. Application analysis software agent 314 can execute such process management commands to obtain OS-level process metadata 214 on behalf of application analysis system 132. Example process metadata includes process name, process identifier (PID), executable path, executable version, command line parameters, working directory, environment variables, start time, owner/user, open sockets, previously open sockets, and the like.

At step 504, application analysis software 132 receives network flow data 216. In embodiments, application analysis software 132 receives VM-level network event data from application analysis software agent 314 (506). Application analysis software agent 314 can obtain network event data from guest OS 312 using a network event library (e.g., libnetfilter). A network event can include, for example, the protocol, lifetime, state, original direction, reply direction, and the like. Original direction information can include source IP, destination IP, source port, and destination port (source tuple). Reply direction information can include source IP, destination IP, source port, and destination port (reply tuple). Network flow data 216 can include a plurality of such network events obtained from VMs 131/140.

In embodiments, application analysis software 132 receives SDDC-level network flow data from network analyzer 113 (508). SDDC-level network flow data includes network flow records collected from sources in host cluster 118 (e.g., DVS 308). A network flow record can include protocol, timestamp, traffic type, firewall action, source identifiers, destination identifiers. Source and destination identifiers can include virtualization management server ID, VM ID, port, source IP, destination IP, cluster ID, host ID, SDDC ID, datastore folder, and the like.

At step 510. application analysis software 132 receives inventory data from virtualization management server 116 of the target SDDC. Such inventory data can include, for example, VM IDs matching input IP addresses. For example, application analysis software 132 can obtain an IP address from a network event and query virtualization management server 116 for a VM ID associated with that IP address.

At step 512, parse logic 418 of application analysis software 132 parses the collected metadata to generate process information (info) objects 402 and network info objects 410. Process info objects 402 include process metadata 404, open socket list 406, and previously open socket list 408. Process metadata 404 includes fields for storing the various process metadata collected in OS-level process metadata 214 (e.g., process name, process identifier (PID), executable path, executable version, command line parameters, working directory, environment variables, start time, owner/user, and the like). Open socket list 406 includes currently open sockets for the process (e.g., local port, local address, remote port, remote address, connection type, socket state, etc.). Previously open socket list 408 includes a list of sockets once used by the process (e.g., local port, local address, remote port, remote address, connection type, socket state, etc.). Network info object 410 includes source identity 412, destination identity 414, and flow data 416. Source identity 412 can include virtualization management server ID, VM ID, source port, source IP, cluster ID, host ID, SDDC ID, datastore folder, and the like. Destination identity 414 can include virtualization management server ID, VM ID, destination port, destination IP, cluster ID, host ID, SDDC ID, datastore folder, and the like. Flow data 416 can include protocol, timestamp, traffic type, firewall action, and the like.

At step 514, matching logic 420 of application analysis system 132 performs metadata matching using process info objects 402 and network info objects 410 as parametric input. In embodiments, at step 516, matching logic 420 relates metadata from network flows and inventory data to determine source and destination VMs. At step 518. matching logic 420 scans process info objects 420 related to source and destination VMs to determine a component-flow topology. At step 520, application analysis system 132 generates topology objects 422 representing discovered component-flow topologies. A topology object 422 includes source component info 424, destination component info 426, and connection data (e.g., protocol, timestamp, etc.). Source component info 424 can include virtualization management server ID, VM ID, process ID, and port. Destination component info 426 can include virtualization management server ID, VM ID, process ID, and port.

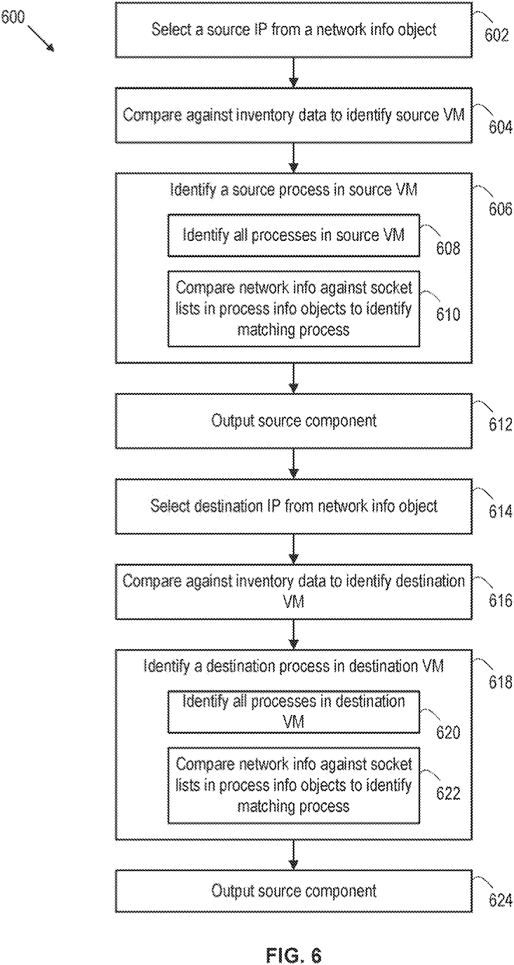

FIG. 6 is a flow diagram depicting a method 600 of identifying source and destination components in the metadata matching process performed by application analysis system 132 according to embodiments. Method 600 begins at step 602, where matching logic 420 selects a source IP from a network info object 410. At step 604, matching logic 420 compares the source IP against inventory data obtained from virtualization management server 116 to identify a source VM. At step 606, matching logic 420 identifies a source process in the source VM. For example, at step 608, matching logic 420 identifies all processes in source VM from process info objects 402. At step 610, matching logic 420 compares network info from the network info object against socket lists in the process info objects to identify a matching process. At step 612, matching logic 420 outputs a source component.

At step 614, matching logic 420 selects a destination IP from the network info object. At step 616, matching logic 420 compares the destination IP against inventory data obtained from virtualization management server 116 to identify a destination VM. At step 618, matching logic 420 identifies a destination process in the destination VM. For example, at step 620, matching logic 420 identifies all processes in destination VM from process info objects 402. At step 622, matching logic 420 compares network info from the network info object against socket lists in the process info objects to identify a matching process. At step 624, matching logic 420 outputs a destination component.

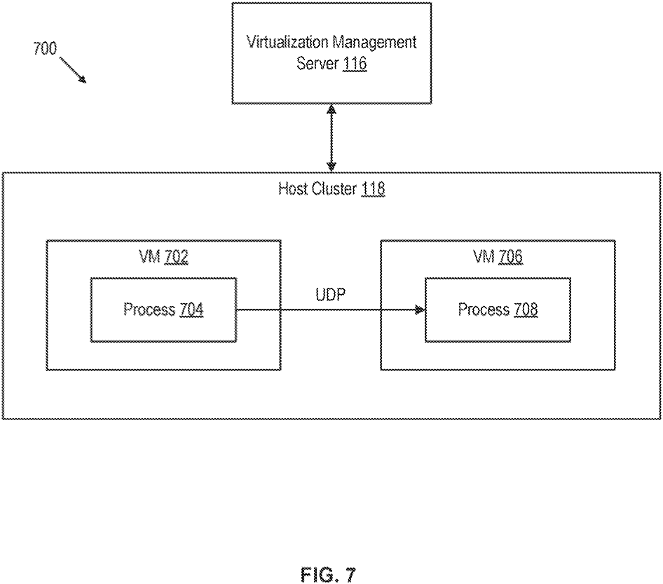

FIG. 7 is a block diagram depicting an example 700 connection between processes according to embodiments. The example presents a single broadcast domain with no proxy server or network address translation (NAT) gateway involved. In this example, each VM 702 and 706 is in the same layer 3 broadcast domain and has a unique IP address. A process 704 in VM 702 has a uniform datagram protocol (UDP) connection with a process 708 in VM 706. VMs 702 and 706 execute in host cluster 118 managed by virtualization management server 116. VMs 702 and 706 are instances of VMs 131/140. In this example, the network topology is such that application analysis system 132 does not require SDDC-level network flow data. OS-level process metadata and VM-level network events along can be used to generate a final component topology.

In the example, assume VM 702 has a VM ID of 1 and an IP address 172.0.0.1. VM 706 has a VM ID of 2 and an IP address of 172.0.0.2. Process 704 has a PID 20 and process 708 has a PID 30. Process 704 establishes a UDP connection through its port 3259 with process 708 through its port 32098. Application analysis system 132 can identify the UDP connection from a network event. Application analysis system 132 queries virtualization management server 116 with the IP addresses 172.0.0.1 and 172.0.0.2 to identify VMs 702 and 706 having VM IDs 1 and 2, respectively. Application analysis system 132 the generates a component topology where the source is identified by virtualization management server ID 000-000-001, VM ID 1, process ID 20, and port 3259. and the destination is identified by virtualization management server ID 000-000-001, VM ID 2, process ID 30, and port 32098. The connection is identified as a UDP connection.

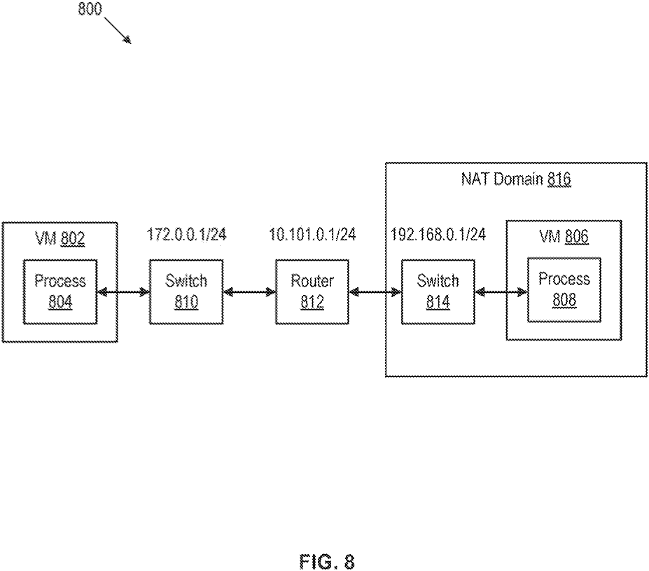

FIG. 8 is a block diagram depicting an example 800 connection between processes according to embodiments. The example presents two VMs connected in a more complex network topology than example 700. A VM 802 is connected to a switch 810 having a subnetwork 172.0.0.1/24. Switch is connected to a router on a subnetwork 10.101.0.1/24. Router 812 provides NAT services for a NAT domain 816, which includes a VM 806. VM 806 is connected to a switch 814 having a subnetwork 192.168.0.1/24. A process 804 in VM 802 establishes a transmission control protocol (TCP) connection with a process 808 in a VM 806. In this scenario, application analysis system 132 can make use of SDDC-level network flow data and OS-level process metadata to generate a final component topology.

In the example, assume VM 802 has a VM ID of 3 and VM 806 has a VM ID of 4. VM 802 has an IP address 172.0.0.1 and VM 806 has an IP address 192.168.0.1. Process 804 has a PID 3001 and connects through port 1506. Process 808 has a PID 4001 and receives connection on port 80. Application analysis system 132 obtains the following network flow record:

flow : {
id: “123-0001”,
traffic_type: “EAST_WEST_TRAFFIC”,
protocol: “TCP”,
flow_tag:[
“EAST_WEST_TRAFFIC” ,“VM_VM_TRAFFIC”, “SRC_IP_VM”,“DST_
IP_VM”, “SAME_HOST”, “NOT_SHARED_SERVICE”, “NETWORK_SWITCHED”,
“UNICAST”, “SRC_VC”,“DST_VC”,“WITHIN_DC”
]
firewall-action : “ALLOW”
}
source : {
ip : 172.0.0.1.
VM : vm-3,
datacenter: dc-1,
cluster: cluster-1,
folder: User-VMs,
host : host-1,
tags: { }
}
},
destination : {
ip : 10.101.0.1,
vm : vm-4,
port: 80,
datacenter: dc-2,
cluster: cluster-2,
folder: Finance-VMs,
host: host-2,
tags: { }
}
}

The example network flow record shows TCP traffic originating on VM 802 (VM ID 3) destined for VM 806 (VM ID 4) at port 80. The only missing data from the network flow record are the process IDs of the communicating processes. Application analysis system 132 correlates the port numbers and timestamps against socket lists in process info objects 402 for VMs 802 and 806 to identify processes 804 and 808. For example, OS-level metadata from VM 802 can include:

{
“process_id”: 3001,
“executable_name”: “python”,
“proc_owner”: “admin”,
“command_line”:“python2 client.py”,
“current_working_directory”: “/home/admin”,
“sockets”: [
{ “socket_type”: “TCP”,
“socket_state”: “ESTABLISHED”,
“local”: {
“port”: 1506,
“address”:“172.0.0.1”
},
“remote”: {
“port”: 80.
“address”:“10.101.0.1”
}
}
}

OS-level metadata from VM 806 can include:

{
“process_id”: 4001,
“executable_name”: “java”,
“proc_owner”: “root”,
“command_line”:“java -jar server.java”,
“current_working_directory”: “/root/”,
“sockets”: [
{
“socket_type”: “TCP”,
“socket_state”: “LISTEN”,
“local”: {
“port”: 80,
“address”:“192.168.0.1 ”
},
“remote”: {
“port”: 1506,
“address”:“ 172.0.0.1”
}
}
}

By comparing the port numbers against the socket lists, application analysis system 132 identifies the processes 804 and 808 and their respective PIDs. Application analysis system 132 then generates the final component topology where the source is identified by virtualization management server ID 000-000-0001, VM ID 3, process ID 3001, and port 1506, and the destination is identified by virtualization management server ID 000-000-002, VM ID 4, process ID 4001, and port 80. This example assumes two separate virtualization management servers managing each VM 802 and 806. The connection between source and destination components is identified as a TCP connection having the associated timestamp obtained from the metadata.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations.

The embodiments described herein may be practiced with other computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer readable media. The term computer readable medium refers to any data storage device that can store data which can thereafter be input to a computer system. Computer readable media may be based on any existing or subsequently developed technology that embodies computer programs in a manner that enables a computer to read the programs. Examples of computer readable media are hard drives, NAS systems, read-only memory (ROM), RAM, compact disks (CDs), digital versatile disks (DVDs), magnetic tapes, and other optical and non-optical data storage devices. A computer readable medium can also be distributed over a network-coupled computer system so that the computer readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Virtualization systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data.

Many variations, additions, and improvements are possible, regardless of the degree of virtualization. The virtualization software can therefore include components of a host, console, or guest OS that perform virtualization functions.

Plural instances may be provided for components, operations, or structures described herein as a single instance. Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined structure or component. Similarly, structures and functionalities presented as a single component may be implemented as separate components. These and other variations, additions, and improvements may fall within the scope of the appended claims.

What is claimed is:

1. A method of determining application topology in a virtualized computing system having a cluster of hosts, the hosts including hypervisors supporting virtual machines (VMs), the method comprising:
executing agents on the VMs to obtain process metadata describing processes executing in the VMs;
receiving, at an application analysis system, the process metadata;
receiving, at the application analysis system, network flow metadata from the agents on the VMs, from a network analyzer in the virtualized computing system, or from both the agents and the network analyzer;
parsing, by the application analysis system, the network flow metadata to identify a source VM and a destination VM of the VMs;
relating, by the application analysis system, the network flow metadata to portions of the process metadata associated with the source and the destination VMs to identify a source process and a destination process; and
generating, by the application analysis system, a topology of a source component connected to a destination component, the source component identifying the source VM and the source process, the destination component identifying the destination VM and the destination process.

2. The method of claim 1, further comprising:
receiving, at the application analysis system, inventory data from a virtualization management server in the virtualized computing system;
wherein the application analysis system identifies the source and the destination VMs by selecting source and destination internet protocol (IP) addresses from the network flow metadata and relating the source and the destination IP addresses with the inventory data.

3. The method of claim 1, wherein the network flow metadata comprises network events obtained by the agents.

4. The method of claim 1, wherein the network flow metadata comprises network flow records collected by the network analyzer from sources in the cluster.

5. The method of claim 4, wherein the sources include a distributed virtual switch implemented by the hypervisors.

6. The method of claim 1, wherein the portions of the process metadata include socket lists.

7. The method of claim 6, wherein the application analysis system relates ports of the network flow metadata to the socket lists to identify the source and the destination processes.

8. A non-transitory computer readable medium comprising instructions to be executed in a computing device to cause the computing device to carry out a method of determining application topology in a virtualized computing system having a cluster of hosts, the hosts including hypervisors supporting virtual machines (VMs), the method comprising:
executing agents on the VMs to obtain process metadata describing processes executing in the VMs;
receiving, at an application analysis system, the process metadata;
receiving, at the application analysis system, network flow metadata from the agents on the VMs, from a network analyzer in the virtualized computing system, or from both the agents and the network analyzer;
parsing, by the application analysis system, the network flow metadata to identify a source VM and a destination VM of the VMs;
relating, by the application analysis system, the network flow metadata to portions of the process metadata associated with the source and the destination VMs to identify a source process and a destination process; and
generating, by the application analysis system, a topology of a source component connected to a destination component, the source component identifying the source VM and the source process, the destination component identifying the destination VM and the destination process.

9. The non-transitory computer readable medium of claim 8, further comprising:
receiving, at the application analysis system, inventory data from a virtualization management server in the virtualized computing system;
wherein the application analysis system identifies the source and the destination VMs by selecting source and destination internet protocol (IP) addresses from the network flow metadata and relating the source and the destination IP addresses with the inventory data.

10. The non-transitory computer readable medium of claim 8, wherein the network flow metadata comprises network events obtained by the agents.

11. The non-transitory computer readable medium of claim 8, wherein the network flow metadata comprises network flow records collected by the network analyzer from sources in the cluster.

12. The non-transitory computer readable medium of claim 11, wherein the sources include a distributed virtual switch implemented by the hypervisors.

13. The non-transitory computer readable medium of claim 8, wherein the portions of the process metadata include socket lists.

14. The non-transitory computer readable medium of claim 13, wherein the application analysis system relates ports of the network flow metadata to the socket lists to identify the source and the destination processes.

15. A virtualized computing system having a cluster comprising hosts connected to a network, the hosts including hypervisors, the virtualized computing system comprising:
virtual machines (VMs) executing on the hypervisors, the VMs executing agents to obtain process metadata describing processes executing in the VMs; and
a server configured to execute an application analysis system, the application analysis system configured to:
receive the process metadata;
receive network flow metadata from the agents on the VMs, from a network analyzer in the virtualized computing system, or from both the agents and the network analyzer;
parse the network flow metadata to identify a source VM and a destination VM of the VMs;
relate the network flow metadata to portions of the process metadata associated with the source and the destination VMs to identify a source process and a destination process; and
generate a topology of a source component connected to a destination component, the source component identifying the source VM and the source process, the destination component identifying the destination VM and the destination process.

16. The virtualized computing system of claim 15, wherein the application analysis system is configured to receive inventory data from a virtualization management server in the virtualized computing system, and wherein the application analysis system identifies the source and the destination VMs by selecting source and destination internet protocol (IP) addresses from the network flow metadata and relating the source and the destination IP addresses with the inventory data.

17. The virtualized computing system of claim 15, wherein the network flow metadata comprises network events obtained by the agents.

18. The virtualized computing system of claim 15, wherein the network flow metadata comprises network flow records collected by the network analyzer from sources in the cluster.

19. The virtualized computing system of claim 18, wherein the sources include a distributed virtual switch implemented by the hypervisors.

20. The virtualized computing system of claim 15, wherein the portions of the process metadata include socket lists, and wherein the application analysis system relates ports of the network flow metadata to the socket lists to identify the source and the destination processes.
